(19) United States
(12) Patent Application Publication
(10) Pub. No.: US 2003/0140518 A1
(43) Pub. Date: Jul. 31, 2003

(54) Handgrip drying device and method

(76) Inventor: Charles F. Rose, Greenville, NC (US)

Correspondence Address: OLIVE & OLIVE, P.A., 500 MEMORIAL STREET, PO BOX 2049, DURHAM, NC, 27702, US

(21) Appl. No.: 10/059,498

(22) Filed: Jan. 29, 2002

(51) Int. Cl. F26B 9/00

(52) U.S. Cl. 34/164

(57) ABSTRACT

A handgrip drying device comprises a bag-like, tubular body containing a moisture absorbing material and sealed with hook-and-loop fasteners. A moist or wet equipment handgrip is dried by placing it in the bag-like, tubular body, which then is shaken to bring all portions of the equipment handgrip that are contained in the bag-like tubular body into contact with the moisture absorbing material.

### FIELD OF THE INVENTION

This invention relates to athletic equipment accessories, and specifically to a device and method for drying a moist handgrip portion of a piece of athletic equipment.

### BACKGROUND OF THE INVENTION

One of the problems encountered by athletes while playing golf, squash, badminton, lacrosse, baseball, tennis, and the like is maintaining a secure grip on the equipment handle. In wet weather, or during a prolonged sports event where the athlete becomes soaked with sweat that is then transferred from the hands to the equipment grip, the equipment becomes slippery and difficult to hold securely. This results in a loss of control and poorer performance; it also can result in injuries to the player, other participants, or spectators. Similar problems can arise with equipment handles that are used in other circumstances, such as, for example, hammer handles.

A conventional means for overcoming the problem is for the equipment user to dry the equipment handgrip by wiping it with a terry cloth, towel, or other material. This is only a temporary solution because after multiple uses, the towel or cloth itself becomes wet and no longer is useful in drying the equipment handgrip.

U.S. Pat. No. 4,934,066 for a Golf Club Handle Drying Device, issued to the inventor of the subject invention on Jun. 19, 1990, relates to a device for drying a golf club grip. The device includes a golf club handgrip drying device having a rigid tubular body, a closed bottom end, and an openable top end. The device contains a quantity of moisture absorbing material. The top end of the tubular body has a circular opening surrounded by a circular brush cylinder in which the brush bristles preferably are directed inward. The handgrip portion of the golf club is inserted into the tubular body through the open top end and contacted with the moisture absorbing material to enable drying of the handgrip. When the handgrip portion is removed from the tubular body, the brush bristles remove most of the moisture absorbing material.

While applicant's prior invention has offered a better working, more efficient handgrip drying device than those previously available, it is desirable to have a device that is easier to carry and maintain.

Therefore, it is an object of the present invention to provide a handgrip drying device that is simple and economical to manufacture.

A further object of the invention is to provide a handgrip drying device that can be kept with the user ready for use at anytime as needed.

It is a further object of the invention to provide a handgrip drying device that retains its drying capacity after many uses.

It is a still further object of the invention to provide a handgrip drying device incorporating a moisture absorbing material that can be refilled easily when the moisture absorbing material needs replenishing.

Other objects and advantages of the invention will be more fully apparent from the following disclosure and appended claims.

### SUMMARY OF THE INVENTION

The present invention is directed to an apparatus and method to dry the handgrip portion of a piece of athletic equipment. The present invention contemplates a device comprising a bag-like, non-rigid tubular body containing a quantity of moisture absorbing material. The top end of the tubular body has a circular opening and is held closed using hook-and-loop fasteners such as Velcro brand fasteners available from Velcro U.S.A Inc. of Manchester, N.H., U.S.A., or the like. The body is preferably a bag-like body made from a pliable and flexible material, such as nylon or plastic sheeting or a woven material. A moisture absorbing material is added to the tubular body by pouring it in the open end thereof. The moisture absorbing material may comprise, for example, a powdery silica drying material or other moisture absorbing material that will retain its drying capacity even after extensive and repeated use. When the handgrip drying device is used, the handgrip portion of the equipment is inserted into the tubular body through the open top end and is brought into contact with the moisture absorbing material in the tubular body, to enable drying of the handgrip portion. The open end of the tubular body is sealed by squeezing the edges of the body around the handgrip portion of the piece of equipment. The hook-and-loop closing material assists in the sealing process. The tubular body with the handgrip therein is then shaken, inverted, and/or rotated so that the moisture absorbing material can fully contact the equipment handgrip. When the equipment handgrip is removed from the tubular body, the hook-and-loop fastening device at the open end helps to brush off any moisture absorbing material that might still be on the handgrip.

The present invention and its features and advantages will be more fully understood, and further features and advantages will become apparent, when reference is made to the following detailed description of the invention, including the drawings, and to the claims.

### BRIEF DESCRIPTION OF THE DRAWINGS

FIG. 1 is a perspective view of a handgrip drying device according to the present invention.

FIG. 2 is a side elevation view of a bag portion of the present invention with, for illustration, a golf club shaft and handgrip illustrated in dashed lines and inserted into the handgrip drying device.

FIG. 3 is a top plan view of the handgrip drying device according to the present invention in a semi-open position with a conventional golf club handle and shaft inserted therein.

FIG. 4 is an enlarged, cross-sectional view of the device illustrating the interior of the bag portion of FIG. 1 and taken substantially along line 4-4 thereof.

FIG. 5 is a top plan view of the handgrip drying device of FIG. 3, with the top portion closed around a conventional golf club handgrip and shaft.

### DESCRIPTION OF THE PREFERRED EMBODIMENT

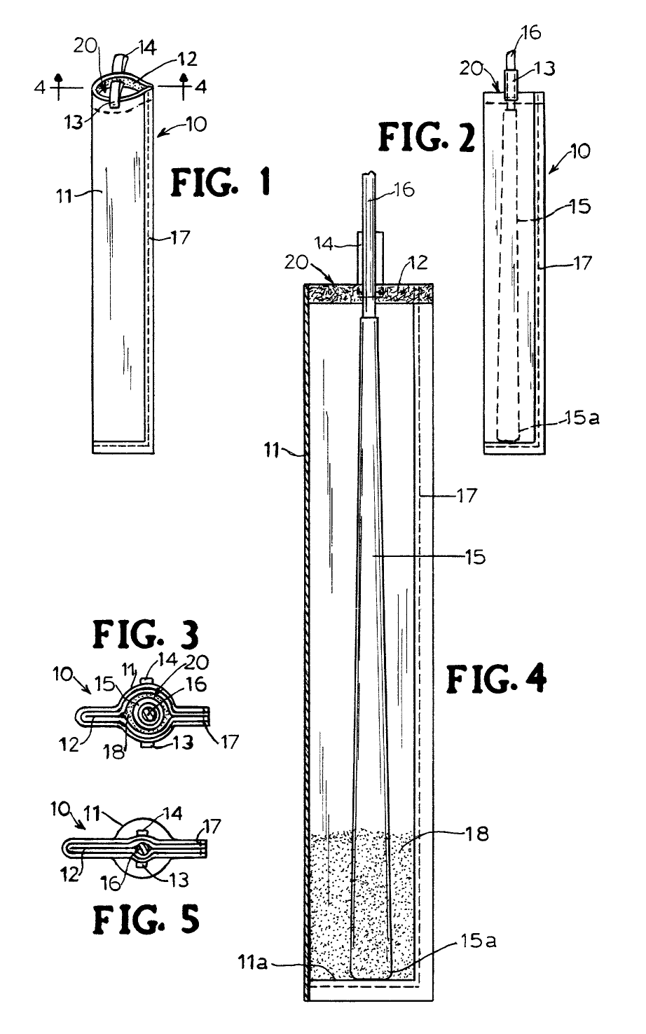

Referring to the drawings in detail, wherein like numerals indicate like elements, there is shown in FIGS. 1-5, a preferred embodiment of the handgrip drying device 10 of the present invention. Handgrip drying device 10 comprises a tubular body 11, end closure fastening strip 12, and opening tabs 13, 14. A fragmentary portion of a conventional golf club shaft 16 and handgrip 15 are shown in FIGS. 2, 3, 4, and 5 for purposes of illustration of the present invention.

Tubular body 11 is made from a pliable material, for example, a woven material, fabric, nylon, or plastic sheeting that preferably is substantially impervious to liquids. Tubular body 11 is formed from one or more sheets of pliable material having a predetermined length that is longer than the conventional handgrip portion of a piece of athletic equipment to be dried, which in this embodiment is illustrated as a conventional golf club. If a single flat sheet of pliable material is used, the pliable material is folded over itself and stitching 17 hold the open edges together. While stitching 17 is illustrated as a way to close the open edges, along its bottom and then along the open long side thereof, other methods, such as gluing, could also be used. Once stitching 17 are completed, only top 20 of tubular body 11 remains open. Along the inner top peripheral edge of body 11, end closure material, in this embodiment, fastening strip 12 is stitched, glued, or otherwise securely fastened thereto.

While end closure material 12 could take other forms, e.g. drawstring, zipper, buttons, snaps, etc., preferably, end closure material 12 is a hook-and-loop type of material, for example, VELCRO. End closure material 12 will be referred to hereafter as VELCRO strip 12.

When top 20 of tubular body 11 is pressed together, VELCRO strip 12 closes tubular body 11 so that anything stored therein cannot escape (FIG. 5). Handgrip drying device 10 has internal dimensions sufficient to contain the handgrip portion of the equipment to be dried, in this case, a conventional golf club handgrip.

According to this embodiment, one or more opening tabs 13, 14 are stitched or otherwise securely fastened to the outer top edges of tubular body 11 for the purpose of aiding in the opening of top 20 of tubular body 11. In operation, as tab 13 is grasped in one hand and tab 14 is grasped in the other hand and then pulled away from each other, VELCRO strip12 separates and top 20 of tubular body 11 is opened.

Before initial use, moisture absorbing material 18, e.g. a powdered silica, silica gel or resin, is poured loosely into the interior of tubular body 11 and is allowed to settle to the bottom thereof (see FIG. 4). The amount of moisture absorbing material to be used is not critical. The amount should be sufficient to ensure that enough moisture absorbing material 18 is used so that virtually the entire handgrip 15 is contacted by the moisture absorbing material when handgrip drying device 10 is shaken, inverted or otherwise rotatated so as to dry handgrip 15.

Handgrip 15 is inserted into handgrip drying device 10 so that end 15a thereof first enters handgrip drying device 10 and substantially all of handgrip 15 is enclosed in tubular body 11. VELCRO strip 12 is then pressed together so that it locks securely around shaft 16, as illustrated in FIG. 5, and closes top 20 of handgrip drying device 10. Handgrip drying device 10 can then be shaken, inverted, or rotated to produce contact between moisture absorbing material 18 and handgrip 15. After such shaking and rotation as is desired, handgrip 15 may be removed immediately from handgrip drying device 10, or alternatively it may be retained inside handgrip drying device 10 until the equipment is to be used. When handgrip 15 is removed from tubular body 11, the hook-and-loop VELCRO strip 12 at the open end helps to brush off any moisture absorbing material 18 that may still be adhered to handgrip 15.

Another advantageous feature, not illustrated, is to have terry cloth or other rough material within tubular body 11 to assist in removal of moisture absorbing material from handgrip 15. While not shown, a terry cloth lining sheet may also be used, or the single sheet of pliable material may be different in nature, and rougher, on the side that will form the interior of tubular body 11. As handgrip 15 is withdrawn from tubular body 11, it would be rubbed against or squeezed between the rough interior side of pliable, tubular body 11 either before being withdrawn or while being withdrawn from tubular body 11 so that moisture absorbing material 18 is brushed from handgrip 15.

While tabs 13 and 14 assist in opening handgrip drying device 10, they are not necessary to its operation. Tabs 13 and 14 can be eliminated altogether, or other means that assist in opening top 20 of tubular body 11 may be used. Such means might include, for example, rings affixed to the upper portion of the exterior of tubular body 11, or simply the upper edges of tubular body 11 that protrude above the height of VELCRO strip 12.

While not illustrtaed, handgrip drying device 10 may be equipped with loops, hooks, or other fasteners designed to facilitate attachment of handgrip 10 to a golfer's cart, to a golf or tennis bag, to a bat rack, to a carpenter's apron, or to other locations that will render it more easily accessible to the user.

From the description herein, it will be readily apparent that numerous changes and modifications can be made without departing from the spirit of the invention. All of such changes and modifications are contemplated as being within the scope of the invention.

What is claimed is:

1. A handgrip drying device, comprising:
(a) a non-rigid tubular body having an openable and closeable top area, and internal dimensions sufficient to contain a handgrip portion of a piece of athletic equipment or tool;
(b) a closure device positioned inside of and about said top area of said non-rigid tubular body;
(c) a moisture absorbing material located within said non-rigid tubular body; and
(d) a removal device located within said non-rigid tubular body adjacent to said top area; said removal device being positioned so as to remove said moisture absorbing material on said handgrip when said handgrip is withdrawn from said handgrip drying device.

2. A handgrip drying device as claimed in claim 1 wherein said non-rigid tubular body is made from a pliable, flexible material.

3. A handgrip drying device as claimed in claim 2 wherein said pliable, flexible material is nylon or plastic sheeting.

4. A handgrip drying device as claimed in claim 1 wherein said moisture absorbing material is a desiccant material comprising a silica material.

5. A handgrip drying device as claimed in claim 1 wherein said closure device is a hook-and-loop fastening secured to an internal top peripheral wall of said non-rigid tubular body.

6. A handgrip drying device as claimed in claim 1 further comprising a pair of tabs attached to outer top edges of said non-rigid tubular body; said tabs being positioned on said non-rigid tubular body to allow said tabs to be grasped individually and pulled away from each other effecting opening of said non-rigid tubular body.

7. A handgrip drying device as claimed in claim 1 wherein said material removal device is integrally formed with said closure device.

8. A pliable golf club handgrip drying device, comprising:
(a) a non-rigid bag having an open end, and having an internal dimension sufficient to contain a golf club grip and of containing a sufficient amount of moisture absorbing granular material to dry said golf club grip when inserted into said non-rigid bag;
(b) a pliable closure mechanism formed within said non-rigid bag at said open end, adapted to selectively open or close said open end to prevent leakage of said moisture absorbing granular material from said non-rigid bag; and
(c) a granular material removal area located within said non-rigid bag to remove said moisture absorbing granular material from said golf club grip as said golf club grip is removed from said non-rigid bag.

9. A pliable golf club handgrip drying device according to claim 8 wherein said non-rigid bag is made of a woven material.

10. A pliable golf club handgrip drying device according to claim 8 wherein said non-rigid bag is made of substantially waterproof material.

11. A pliable golf club handgrip drying device according to claim 8 wherein said non-rigid bag is made of nylon or plastic sheeting.

12. A pliable golf club handgrip drying device according to claim 8 wherein said moisture absorbing granular material is a desiccant comprising a silica material.

13. A pliable golf club handgrip drying device according to claim 8 wherein said pliable closure mechanism is a hook-and-loop type fastening strip secured to an internal top peripheral wall of said non-rigid bag.

14. A pliable golf club handgrip drying device according to claim 8, further comprising a pair of tabs attached to an outer top edge of said non-rigid bag; said tabs being positioned on said non-rigid bag to allow said tabs to be grasped individually and pulled away from each other effecting opening of said non-rigid bag.

15. A pliable golf club handgrip drying device according to claim 8 wherein said granular material removal area is formed integrally with said pliable closure mechanism.

16. A method for drying a golf club handgrip, comprising:
(a) forming an elongate body out of a pliable material, with an open end and a closed end, said elongate body having a pliable closure device formed in said elongate body, at said open end;
(b) placing a predetermined amount of a moisture absorbing material in said elongate body;
(c) inserting a golf club handgrip into said elongate body;
(d) closing said open end about said golf club handgrip;
(e) coating said golf club handgrip in said elongate body width said moisture absorbing material;
(f) opening said open end of elongate body;
(g) removing said golf club handgrip from said elongate body; and
(h) removing said moisture absorbing material from said golf club handgrip as said golf club handgrip is removed from said elongate body.

17. A method for drying a golf club handgrip according to claim 16, further comprising forming said elongate body from a woven material.

18. A method for drying a golf club handgrip according to claim 16, further comprising forming said elongate body from a substantially waterproof material.

19. A method for drying a golf club handgrip according to claim 16, further comprising forming said elongate body from nylon or plastic sheeting.

20. A method for drying a golf club handgrip according to claim 16, wherein said moisture absorbing material is a desiccant comprising a silica material.

21. A method for drying a golf club handgrip according to claim 16, further comprising forming said pliable closure mechanism with a hook-and-loop type fastening strip and securing said hook-and-loop type fastening strip to an internal top peripheral wall of said elongate body.

22. A method for drying a golf club handgrip according to claim 16, further comprising forming a pair of tabs on an outer top edge of said elongate body.

23. A method for drying a golf club handgrip according to claim 22, further comprising opening said elongate body by grasping said tabs individually and pulling said tabs away from each other.

24. A method for drying a golf club handgrip according to claim 16, further comprising removing said moisture absorbing material with said pliable closure mechanism.

25. A method for drying a golf club handgrip according to claim 16, further comprising removing said moisture absorbing material with a material removing device located inside of said elongate body.

26. A method for drying a golf club handgrip in a flexible elongate body carried by a golfer, comprising:
(a) Inserting a golf club handgrip into an open end of an elongate body made of a flexible material and containing a predetermined amount of said moisture absorbing material;
(b) closing said open end by squeezing said open end about said golf club handgrip;
(c) coating said golf club handgrip in said elongate body with said moisture absorbing material by shaking and inverting said elongate body;
(d) opening said open end after shaking and inverting said elongate body;
(e) removing said golf club handgrip from said elongate body; and
(f) removing said moisture absorbing material from said golf club handgrip as said golf club handgrip is removed from said elongate body.
